(19) United States
(12) Patent Application Publication
(10) Pub. No.: US 2022/0105703 A1
(43) Pub. Date: Apr. 7, 2022

(54) CARBON FIBER REINFORCED SKATEBOARD

(71) Applicant: James Blackmarr Wursthorn, Las Vegas, NV (US)

(72) Inventor: James Blackmarr Wursthorn, Las Vegas, NV (US)

(21) Appl. No.: 17/061,823

(22) Filed: Oct. 2, 2020

(51) Int. Cl. B32B 5/06; B32B 21/04; C09J 131/04; B32B 7/12; B32B 21/10; A63C 17/01

(52) U.S. Cl. CPC B32B 5/06; B32B 2262/106; C09J 131/04; B32B 7/12; B32B 21/10; A63C 17/017; A63C 17/012; A63C 17/015; B32B 2250/05; B32B 2260/026; B32B 2260/021; B32B 2305/08; B32B 2305/188; B32B 2307/54; B32B 2307/544; B32B 2307/546; B32B 2307/558; B32B 2331/04; B32B 2313/04; B32B 21/042

(57) ABSTRACT

A carbon fiber reinforced skateboard is formed of laminated wood layers having identified grain directions. Upper and lower wood layers will have a grain direction parallel to a long axis of the skateboard. The skateboard will have interspersed wood layers with identified grain directions perpendicular to the long axis. Carbon fiber reinforcing material is adhered to interior plies of the skateboard along the long axis. A central portion of the reinforcing material is adhered below a central vertical point of the skateboard between the skateboard trucks. Anterior and posterior portions of the reinforcing material are adhered above the central vertical point and are located around the attachment locations for the skateboard trucks. The reinforcing material is located to provide a strengthened spine for the skateboard. A first concavity is located between the skateboard trucks parallel to the long axis. Second and third concavities are located perpendicular to the long axis.

### FIELD OF INVENTION

This invention relates to the field of skateboards and methods for their construction and more specifically to skateboards and their construction that include the application of high-strength reinforcing layers in the skateboard construction.

### BACKGROUND OF THE INVENTION

Skateboard riding has become a highly skilled and demanding sport. This sport requires a skateboard that has certain specific features. The skateboard must have certain size, dimensions, weight and flex features to provide the desired performance. Of these features, the flex characteristics of the skateboard are likely the most important and also the most difficult to build into the skateboard. In high performance applications, there are often extreme forces acting on the skateboard. Construction of a skateboard that provides the desired flex characteristics while providing sufficient strength and durability is a challenging manufacturing task. In addition, certain weight and dimension characteristics must be maintained. Skateboards have historically been constructed of wood or molded plastic. More durable, higher strength skateboards have been constructed of laminated wood plies. Some skateboards have incorporated interleaved layers of reinforcing material to lend durability and certain flex characteristics to the skateboard. The following are examples of skateboard inventions that have been developed to meet the demands of the sport.

U.S. Pat. No. 7,735,844, issued to Gallo, discloses a wooden skateboard comprising a stack of laminated wooden layers, and at least two non-wooden material layers (carbon fiber layer inserts) interspersed between the wooden layers, wherein a first such non-wooden layer is inserted between the top two laminated wooden layers, a second non-wooden layer is inserted in the region defined between the bottommost two layers, thus providing enhanced reinforcement strength to the skateboard, while simultaneously retaining its flexible characteristics.

U.S. Patent Application No. 2008/0231009, published for Hill et al., is directed to a laminated wooden skateboard having a core member made of multiple (preferably three) layers of carbon-fiber insert material & an exterior wooden portion surrounding the core member. The exterior wooden portion covering the core member at its top & bottom portion includes different layers of wood stacked over one another. Further, the multiple layers can be assembled using a lamination process. An adhering material is used to bind the non-wooden material layers to the wooden layers.

U.S. Patent Application No. 20080238013, published for Woodall et al. illustrates a skateboard comprising a seven-layered stacked structure of wooden material. Between the bottommost two wooden layers, multiple support members for reinforcement are inserted, which are in ovoid form in one embodiment. The support member can be made of carbon fiber material in one embodiment. Further, these carbon fiber members are cured prior to insertion between the two bottommost wooden layers of the seven-layered laminated wooden stack forming the skateboard. Further, the individual wooden layers of the seven-layer stack are glued, pressed together & laminated to provide the final assembled shape to the skateboard deck structure.

U.S. Patent Application No. 20090108554, published for Boyle et al., is directed to a skateboard deck comprising a multiple-layer stack (seven-layered structure in a preferred embodiment) of wooden plies. Elongated slots are provided in the middle three layers, wherein elongated tubular rods, which may be composed of carbon fiber material, are inserted into the elongated slots, for providing reinforcement to the skateboard. Further, the patent discloses a method of forming such a skateboard, wherein an adhesive, such as an epoxy material is applied between the juxtaposed wooden layers within the seven-layered stack of the skateboard deck to bond and press these layers over each other during the process of assembling.

U.S. Pat. No. 6,059,307, issued to Western, illustrates a skateboard deck comprising a core, which is composed of aspen or poplar wood, and made of multiple, longitudinal portions that are glued to one another. Filler pieces are provided on the core for additional reinforcement. These filler pieces may be made of carbon fiber material and are held in place by an epoxy resin.

U.S. Patent Application No. 2011/0151175, published for Gallo, discloses a skateboard having a multi-layered stack of wooden piles placed atop each other, with non-wooden material layers inserted between the respective wooden piles. The non-wooden material may be carbon fabric in one embodiment. In a preferred embodiment, the stack is composed by five wooden layers & four non-wooden layers, one each being inserted between a respective pair of adjacent wooden layers. Further, the width & thickness of each non-wooden layers is determined by a specific formula. The individual layers are glued together during the process of assembling the deck.

U.S. Pat. No. 6,182,986, issued to Smith, is directed a multi-layered stack of laminated wooden & non-wooden piles positioned atop each other. The non-wooden layers are preferably made of carbon fabric material and are inserted between specific pairs of adjacent wooden layers. According to one embodiment, the third, eighth and fifth layer in the multi-layered, stacked combination are made of carbon fiber material. Altogether, the stack includes fifteen layers in this embodiment, wherein 12 of these layers are made of a wooden material.

U.S. Patent Application No. 2008/0296858, published for Burwell, describes a skateboard deck comprising a stack of multiple layers, and more specifically, seven layers, formed as a miscellaneous combination of wooden & non-wooden materials. The layers of non-wooden material may be formed of a carbon composite. Further, layers can be arranged in any order. During the process of assembling the skateboard, any suitable glue, resin or other adhesive material can be used for binding the layers of the stack to one another.

U.S. Patent Application No. 2003/0102650, published for Gordon, is directed to a multi-layered stack forming the skateboard deck that includes a top & bottom layer, acting as load bearing layers and formed of a strong resilient material, such as natural-fiber embedded matrix. A light and flexible core portion is disposed between the top & bottom layers, and is formed of a stack of multiple layers, wherein each layer may be of wooden material, carbon fiber or any other material for that matter, which is relatively more flexible & light in comparison to the top and bottom structural layers dispenser that includes the following components.

U.S. Patent Application No. 2005/0115470, published for Schmitt, discloses a skateboard deck that includes a wooden core positioned between a top and a bottom cross-band layer, where each cross-band layer is provided with grains. Longitudinal grooves are provided in the wooden core, which are perpendicular to the grains of the cross-band layers. The grooves & the grains together form an I-Beam structure, which provides structural integrity and balance to the skateboard deck. The two cross-band layers are further positioned between a topmost wooden layer and a bottommost wooden layer of the deck. A gluing process is used to form the grooves within the wooden core. As the topmost & the bottommost layers are bonded together to the wooden core, some adhering material appears to be used for the purpose. Further, the topmost and the bottommost layers do not necessarily need to be of wooden material, and may, for example, be of fiberglass in some embodiments.

U.S. Pat. No. 6,527,284, issued to Bert, discloses a skateboard deck that includes a seven-layered stack of wooden plies, specifically maple wood plies, which are glued over each other during the assembling process. The central ply in the deck has an opening, wherein a reinforcement plate is inserted, which covers/aligns with the region of the lower portion of the deck where the trucks are mounted. The reinforcement plate has a higher thickness in the region/zone for mounting the trucks, which provides an additional strength to the deck in that region. Further, the reinforcement plate is also glued to the other wooden plies during the manufacturing process.

Canadian Patent No. CA2656602, issued to Hunter, is directed to a laminated structure of a skateboard that includes multiple layers of veneer hardwood stacked over one another. However, some of the layers within the stack may be formed of an alternative material, such as carbon fibers. The individual layers are glued over one another during the process of assembling the skateboard.

It is an objective of the present invention to provide a high performance skateboard having defined dimensions, weight and flex characteristics. It is a further objective to provide a skateboard that is durable and can withstand the performance demands of the sport. It is a still further objective of the invention to provide a skateboard that can be easily and economically manufactured. Finally, it is an objective of the present invention to provide a skateboard that can be manufactured from readily available and non-toxic materials.

While some of the objectives of the present invention are disclosed in the prior art, none of the inventions found include all of the requirements identified.

### SUMMARY OF THE INVENTION

The present invention addresses all of the deficiencies of prior art carbon fiber reinforced skateboards and satisfies all of the objectives described above.

(1) A carbon fiber reinforced skateboard providing the desired features may be constructed from the following components. An upper layer is provided. The upper layer is formed of at least a first wood ply and has an upper surface. A lower layer is provided. The lower layer is formed of at least a second wood ply and has a lower surface. A core layer is provided. The core layer is formed of at least a third wood ply and is located between the upper layer and the lower layer. First and second skateboard trucks are provided. The skateboard trucks have first and second mounting plates and first and second wheel sets. The wheel sets are rotatably mounted to the skateboard trucks. Mounting hardware is provided which is adapted to attach the mounting plates to at least the lower surface of the lower layer.

Reinforcing material is provided. The reinforcing material is located between the upper layer and the lower layer. An adhesive is provided. The adhesive secures the reinforcing material to at least one of a lower surface of the upper layer, an upper surface of the lower layer or the core layer. The upper layer, the lower layer and the core layer are laminated together using, pressure and industrial wood glue laminating material.

(2) In a variant of the invention, the adhesive is an aliphatic rubbery synthetic polymer.

(3) In another variant, the aliphatic rubbery synthetic polymer has a formula of (C₄H₆O₂)ₙ.

(4) In still another variant, the adhesive is selected from the group consisting of: Polyvinyl acetate (PVA), PVAc and poly(ethenyl ethanoate).

(5) In yet another variant, upper and lower wood plies of the core layer have a defined wood grain direction perpendicular to a wood grain direction of the lower surface of the upper layer and the upper surface of the lower layer.

(6) In a further variant, the core layer comprises at least three plies.

(7) In still a further variant, a center ply of the core layer has a defined wood grain direction parallel to the wood grain direction of the lower surface of the upper layer and the upper surface of the lower layer.

(8) In yet a further variant, the core layer comprises at least five plies.

(9) In another variant of the invention, the center ply of the core layer has the defined wood grain direction parallel to the wood grain direction of the lower surface of the upper layer and the upper surface of the lower layer and wood plies adjacent to the center ply have a defined wood grain direction perpendicular to the defined wood grain direction the center ply.

(10) In still another variant, wood plies adjacent to the lower surface of the upper layer and the upper surface of the lower layer have a defined wood grain direction parallel to the wood grain direction of the upper layer and the lower layer.

(11) In yet another variant, the reinforcing material is selected from the group consisting of: woven carbon fiber fabric, non-crimp stitch bonded carbon fiber fabric, stitch bonded carbon fiber fabric, and 45/−45 double bias carbon fiber fabric.

(12) In a further variant, the reinforcing material includes a center portion. The center portion is located along a lengthwise axis of the skateboard and centered on a perpendicular cross axis of the skateboard. The reinforcing material further includes an anterior portion. The anterior portion is located along the lengthwise axis of the skateboard and centered about mounting holes for the first mounting plate. The reinforcing material further includes a posterior portion. The posterior portion is located along the lengthwise axis of the skateboard and centered about mounting holes for the second mounting plate.

(13) In still a further variant, the center portion is adhered to the core layer on a wood ply located below a vertical center point of the core layer.

(14) In yet a further variant, the anterior portion and the posterior portion are adhered to the core layer on a wood ply located above a vertical center point of the core layer.

(15) In another variant of the invention, the center portion is adhered to a wood ply of the core layer that has a defined wood grain parallel to the wood grain direction of the upper surface of the lower layer.

(16) In still another variant, the anterior portion and the posterior portion are adhered to a wood ply of the core layer that has a defined wood grain parallel to the wood grain direction of the lower surface of the upper layer.

(17) In yet another variant, the center portion is 1″ to 4″ in width and 18″ to 24″ in length.

(18) In a further variant, the anterior portion and the posterior portion are 1″ to 4″ in width and 3″ to 6″ in length.

(19) In still a further variant, the mounting hardware extends through each of the upper layer, core layer and lower layer and is secured against an underside of the mounting plates with threaded fasteners.

(20) In yet a further variant, the industrial wood glue is selected from the group consisting of: polyvinyl acetate (PVA), aliphatic resin, polyurethane, phenol formaldehyde, and resorcinol-formaldehyde.

(21) In another variant of the invention, the reinforcing material ranges from 0.0005″ to 0.0015″ in thickness.

(22) In still another variant, the wood plies range in thickness from range in thickness from 0.05″ to 0.08″.

(23) In another variant of the invention, the upper layer, the lower layer and the core layer further include a first concavity. The first concavity is parallel to the lengthwise axis and extends from a point adjacent the first skateboard truck to a point adjacent the second skateboard truck.

(24) In still another variant, the first concavity ranges from 0.25″ to 1.5″ in depth.

(25) In yet another variant, the upper layer, the lower layer and the core layer further include a second concavity. The second concavity is perpendicular to the lengthwise axis, disposed adjacent the first skateboard truck and extending from a first side edge to a second side edge of the layers.

(26) In a further variant, the second concavity ranges from 0.25″ to 1.5″ in depth.

(27) In still a further variant, the upper layer, the lower layer and the core layer further comprise a third concavity, the third concavity is perpendicular to the lengthwise axis, disposed adjacent the second skateboard truck and extending from a first side edge to a second side edge of the layers.

(28) In yet a further variant, the third concavity ranges from 0.25″ to 1.5″ in depth.

(29) A method of making a carbon fiber reinforced skateboard, includes the steps of: forming an upper layer. The upper layer is formed of at least a first wood ply and has an upper surface. Forming a lower layer. The lower layer is formed of at least a second wood ply and has an lower surface. Forming a core layer. The core layer is formed of at least a third wood ply and is located between the upper layer and the lower layer. Providing first and second skateboard trucks. The skateboard trucks have first and second mounting plates. Providing first and second wheel sets. The wheel sets are rotatably mounted to the skateboard trucks. Providing mounting hardware. The mounting hardware is adapted to attach the mounting plates to at least the lower surface of the lower layer. Providing reinforcing material. The reinforcing material is located between the upper layer and the lower layer. Providing an adhesive. Securing the reinforcing material with the adhesive to at least one of a lower surface of the upper layer, an upper surface of the lower layer or the core layer. Laminating the upper layer, the lower layer and the core layer together using, pressure and industrial wood glue laminating material.

(30) In a variant of the method, the adhesive is an aliphatic rubbery synthetic polymer.

(31) In another variant of the method, the aliphatic rubbery synthetic polymer has a formula of (C₄H₆O₂)ₙ.

(32) In still another variant of the method, the adhesive is selected from the group consisting of: polyvinyl acetate (PVA), PVAc and poly(ethenyl ethanoate).

(33) Yet another variant of the method, further includes the step of orienting a defined wood grain direction of upper and lower wood plies of the core layer perpendicular to a wood grain direction of the lower surface of the upper layer and the upper surface of the lower layer.

(34) A further variant of the method, includes the step of providing the core layer comprises with at least three plies.

(35) Still a further variant of the method, includes the step of orienting a center ply of the core layer, that has a defined wood grain direction, parallel to a wood grain direction of the lower surface of the upper layer and the upper surface of the lower layer.

(36) Yet a further variant of the method, includes the step of providing the core layer comprises with at least five plies.

(37) Another variant of the method of making a carbon fiber reinforced skateboard includes the step of orienting the core layer such that a center ply of the core layer has a defined wood grain direction parallel to a wood grain direction of the lower surface of the upper layer and the upper surface of the lower layer and wood plies adjacent to the center ply have a defined wood grain direction perpendicular to the center ply.

(38) Still another variant of the method includes the step of orienting the core layer such that wood plies adjacent to the lower surface of the upper layer and the upper surface of the lower layer have a defined wood grain direction parallel to a wood grain direction of the upper layer and the lower layer.

(39) Yet another variant of the method includes the step of providing reinforcing material selected from the group consisting of: woven carbon fiber fabric, non-crimp stitch bonded carbon fiber fabric, stitch bonded carbon fiber fabric, and 45/−45 double bias carbon fiber fabric.

(40) A further variant of the method includes the steps of: providing a center portion of the reinforcing material. The center portion is located along a lengthwise axis of the skateboard and centered on a perpendicular cross axis of the skateboard. Providing an anterior portion of the reinforcing material. The anterior portion is located along the lengthwise axis of the skateboard and centered about mounting holes for the first mounting plate. Providing a posterior portion of the reinforcing material. The posterior portion is located along the lengthwise axis of the skateboard and centered about mounting holes for the second mounting plate.

(41) A still further variant of the method includes the step of adhering the center portion to the core layer on a wood ply located below a vertical center point of the core layer.

(42) Yet a further variant of the method includes the step of adhering the anterior portion and the posterior portion to the core layer on a wood ply located above a vertical center point of the core layer.

(43) Another variant of the method of making a carbon fiber reinforced skateboard includes the step of adhering the center portion to a wood ply of the core layer has a defined wood grain parallel to the lower surface of the upper layer.

(44) Still another variant of the method includes the step of adhering the anterior portion and the posterior portion a wood ply of the core layer has a defined wood grain parallel to the upper surface of the lower layer.

(45) In yet another variant of the method, the center portion is 1″ to 4″ in width and 18″ to 24″ in length.

(46) In a further variant of the method, the anterior portion and the posterior portion are 1″ to 4″ in width and 3″ to 6″ in length.

(47) A still further variant of the method includes the steps of: providing apertures for the mounting hardware that extend through the upper layer, the core layer and the lower layer. Inserting the mounting hardware through the apertures. Mounting the first and second mounting plates on the mounting hardware. Securing the first and second mounting plates to the skateboard with threaded fasteners.

(48) Yet a further variant of the method includes the step of providing industrial wood glue selected from the group consisting of: polyvinyl acetate (PVA), aliphatic resin, polyurethane, phenol formaldehyde, and resorcinol-formaldehyde.

(49) Another variant of the method of making a carbon fiber reinforced skateboard includes the step of providing reinforcing material has a thickness ranging from 0.0005″ to 0.009″.

(50) Still another variant of the method includes the step of providing wood plies range in thickness from range in thickness from 0.05″ to 0.08″.

(51) In a further variant of the method, the upper layer, the lower layer and the core layer further include a first concavity, the first concavity is parallel to the lengthwise axis and extending from a point adjacent the first skateboard truck to a point adjacent the second skateboard truck.

(52) In still a further variant of the method, the first concavity ranges from 0.25″ to 1.5″ in depth.

(53) In yet a further variant of the method, the upper layer, the lower layer and the core layer further include a second concavity, the second concavity is perpendicular to the lengthwise axis, disposed adjacent the first skateboard truck and extending from a first side edge to a second side edge of the layers.

(54) In another variant of the method of making a carbon fiber reinforced skateboard, the second concavity ranges from 0.25″ to 1.5″ in depth.

(55) In still another variant of the method, the upper layer, the lower layer and the core layer further comprise a third concavity, the third concavity is perpendicular to the lengthwise axis, disposed adjacent the second skateboard truck and extending from a first side edge to a second side edge of the layers.

(56) In a final variant of the method, the third concavity ranges from 0.25″ to 1.5″ in depth.

An appreciation of the other aims and objectives of the present invention and an understanding of it may be achieved by referring to the accompanying drawings and the detailed description of a preferred embodiment.

### DESCRIPTION OF THE Drawings

FIG. 1 is a perspective view of the carbon fiber reinforced skateboard of the preferred embodiment of the invention;

FIG. 2 is a perspective view of the underside of the FIG. 1 embodiment;

FIG. 3 is a perspective view of the wood ply layers of the of the FIG. 1 embodiment illustrating the placement of reinforcing materials between the plies;

FIG. 4 is a perspective view of the wood ply layers of an alternative embodiment illustrating the placement of reinforcing materials between the plies;

FIG. 5 is a plan view of two of the plies of the FIG. 1 embodiment illustrating the location of the central, anterior and posterior portions of the reinforcing material;

FIG. 6 is a perspective view of a skateboard deck formed of the FIG. 1 embodiment illustrating the first, second and third concavities;

FIG. 7 is plan view of the FIG. 3 embodiment illustrating the mounting apertures for skateboard trucks;

FIG. 8 is a side elevational view of the FIG. 6 embodiment illustrating the first, second and third concavities;

FIG. 9 is a cross-sectional view of the FIG. 6 embodiment taken along the line 6-6;

FIG. 10 is a cross-sectional view of woven carbon fiber fabric;

FIG. 11 is a plan view of the FIG. 7 embodiment;

FIG. 12 is a side elevational view of non-crimp stitch bonded carbon fiber fabric;

FIG. 13 is a plan view of the FIG. 9 embodiment; and

FIG. 14 is a partial sectional perspective view of 45/−45 double bias carbon fiber fabric.

### DETAILED DESCRIPTION OF THE PREFERRED EMBODIMENT

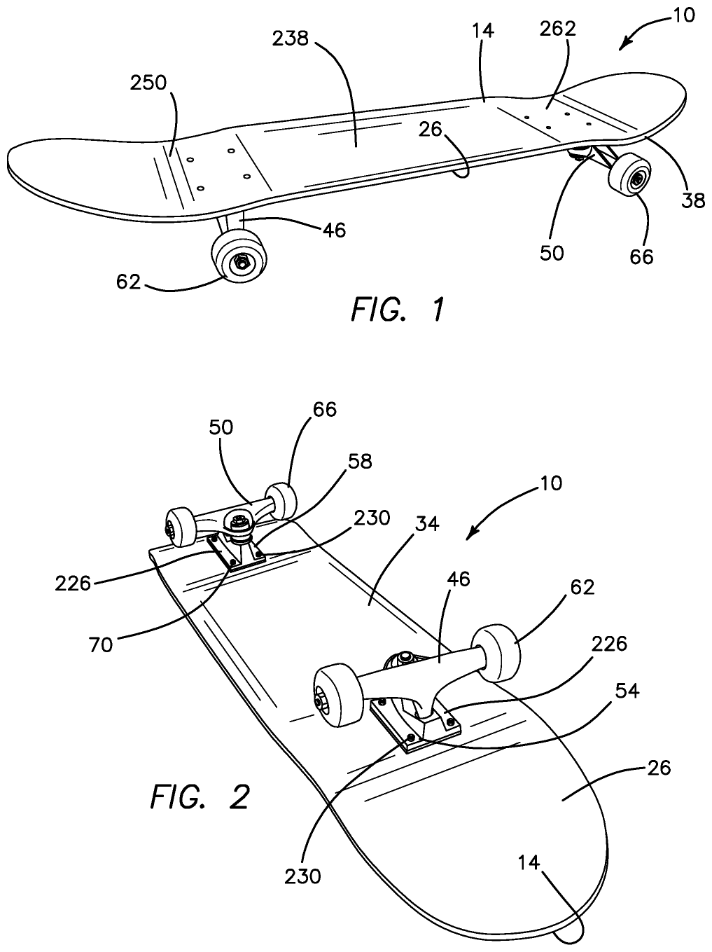

(1) As illustrated in FIGS. 1-3, a carbon fiber reinforced skateboard 10 providing the desired features may be constructed from the following components. An upper layer 14 is provided. The upper layer 14 is formed of at least a first wood ply 18 and has an upper surface 22. A lower layer 26 is provided. The lower layer 26 is formed of at least a second wood ply 30 and has a lower surface 34. A core layer 38 is provided. The core layer 38 is formed of at least a third wood ply 42 and is located between the upper layer 14 and the lower layer 26. First 46 and second 50 skateboard trucks are provided. The skateboard trucks 46, 50 have first 54 and second 58 mounting plates and first 62 and second 66 wheel sets. The wheel sets 62, 66 are rotatably mounted to the skateboard trucks 46, 50. Mounting hardware 70 is provided which is adapted to attach the mounting plates 54, 58 to at least the lower surface 34 of the lower layer 26.

Reinforcing material 74 is provided. The reinforcing material 74 is located between the upper layer 14 and the lower layer 26. An adhesive 78 is provided. The adhesive 78 secures the reinforcing material 74 to at least one of a lower surface 82 of the upper layer 14, an upper surface 86 of the lower layer 26 or the core layer 38. The upper layer 14, the lower layer 26 and the core layer 38 are laminated together using, pressure and industrial wood glue laminating material 90.

(2) In a variant of the invention, the adhesive 78 is an aliphatic rubbery synthetic polymer 94.

(3) In another variant, the aliphatic rubbery synthetic polymer 94 has a formula of (C₄H₆O₂)ₙ.

(4) In still another variant, the adhesive 78 is selected from the group consisting of: Polyvinyl acetate (PVA) 98, PVAc (not shown) and poly(ethenyl ethanoate) (not shown).

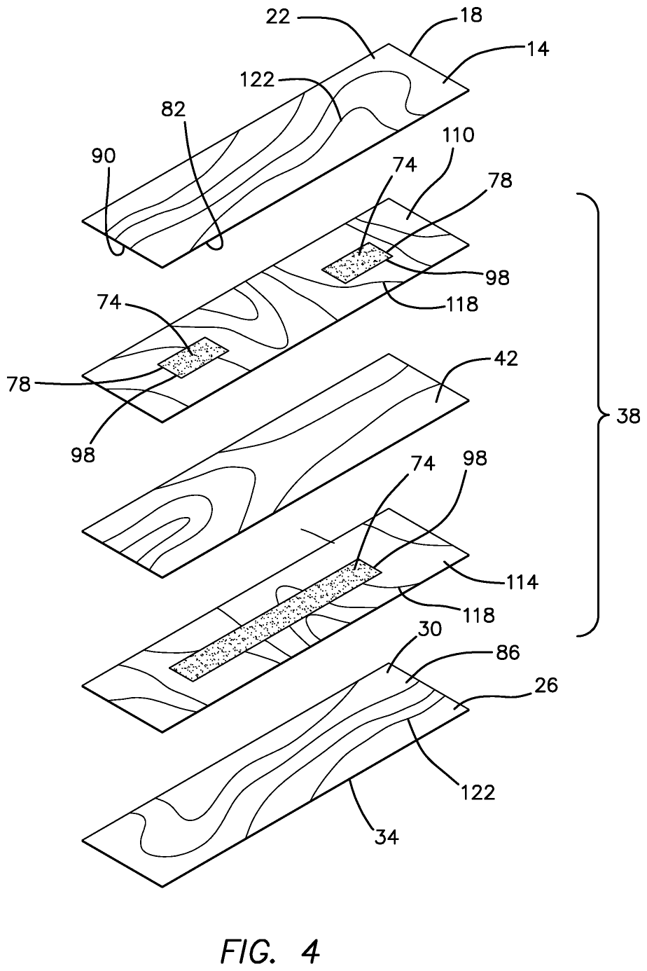

(5) In yet another variant, as illustrated in FIG. 4, upper 110 and lower 114 wood plies of the core layer 38 have a defined wood grain direction 118 perpendicular to a wood grain direction 122 of the lower surface 82 of the upper layer 14 and the upper surface 86 of the lower layer 26. NEW DRAWING

(6) In a further variant, the core layer 38 comprises at least three plies.

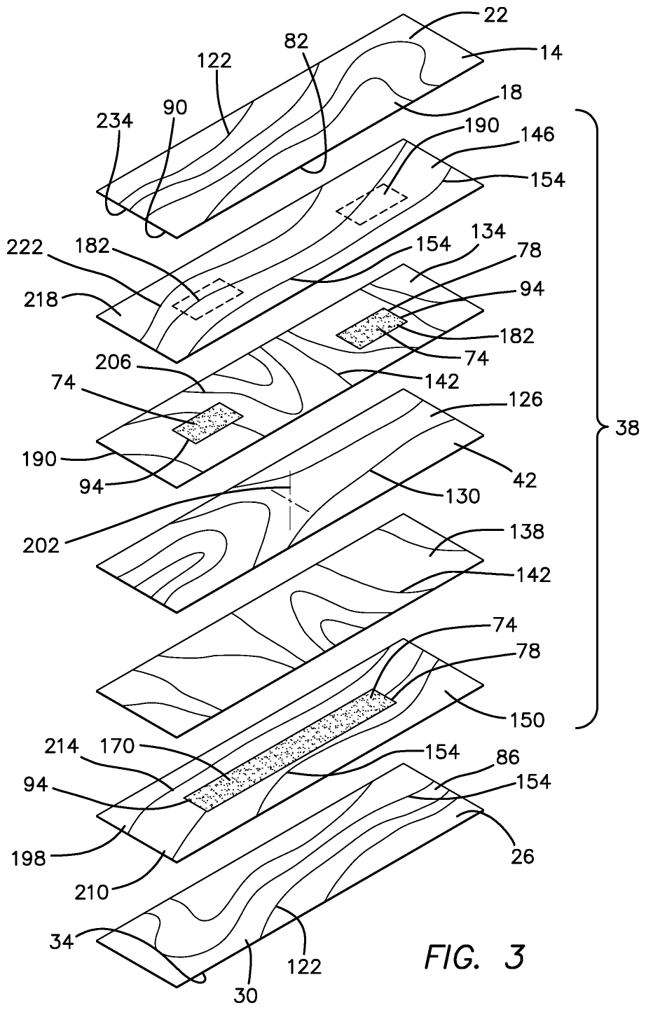

(7) In still a further variant, as illustrated in FIG. 3, a center ply 126 of the core layer 38 has a defined wood grain direction 130 parallel to the wood grain direction 122 of the lower surface 82 of the upper layer 14 and the upper surface 86 of the lower layer 26.

(8) In yet a further variant, the core layer 38 comprises at least five plies.

(9) In another variant of the invention, the center ply 126 of the core layer 38 has the defined wood grain direction 130 parallel to the wood grain direction 122 of the lower surface 82 of the upper layer 14 and the upper surface 86 of the lower layer 26 and wood plies 134, 138 adjacent to the center ply 126 have a defined wood grain direction 142 perpendicular to the defined wood grain direction 130 of the center ply 126.

(10) In still another variant, wood plies 146, 150 adjacent to the lower surface 82 of the upper layer 14 and the upper surface 86 of the lower layer 26 have a defined wood grain direction 154 parallel to the wood grain direction 122 of the upper layer 14 and the lower layer 26.

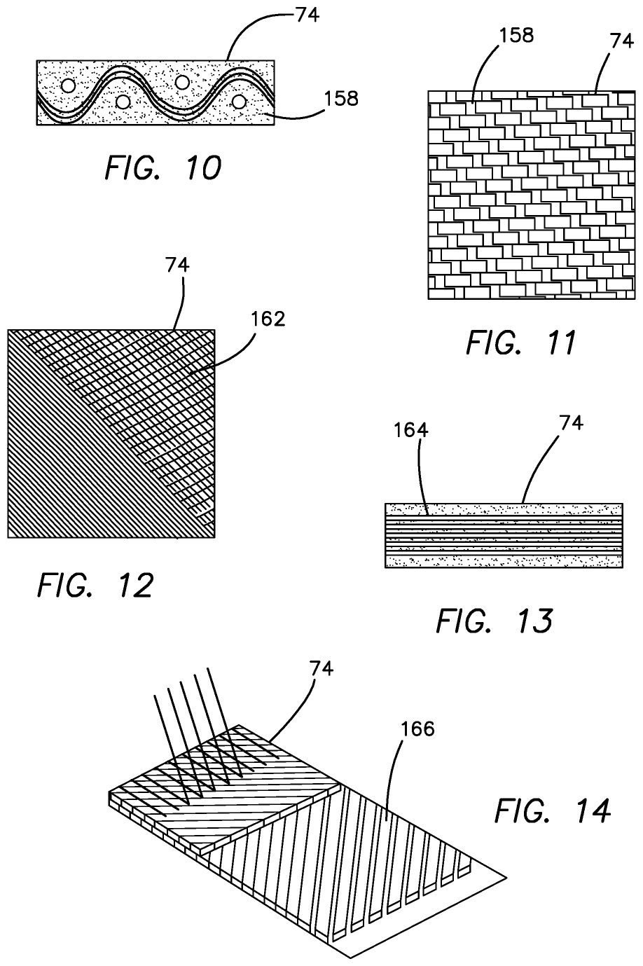

(11) In yet another variant, as illustrated in FIGS. 10-14, the reinforcing material 74 is selected from the group consisting of: woven carbon fiber fabric 158, non-crimp stitch bonded carbon fiber fabric 162, stitch bonded carbon fiber fabric 164 and 45/−45 double bias carbon fiber fabric 166.

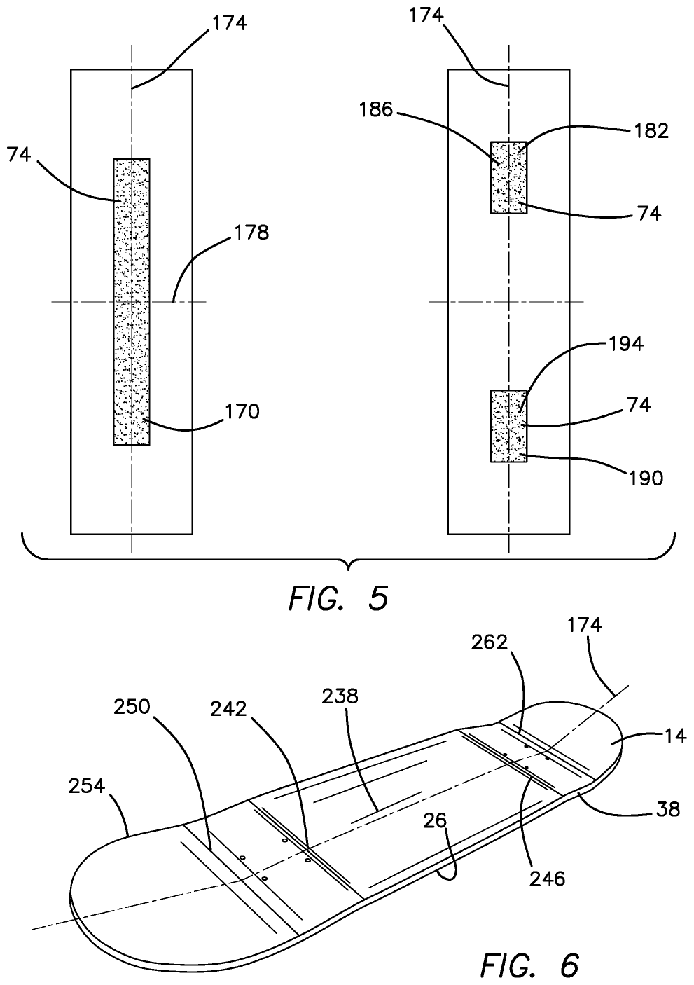

(12) In a further variant, as illustrated in FIG. 5, the reinforcing material 74 includes a center portion 170. The center portion 170 is located along a lengthwise axis 174 of the skateboard 10 and centered on a perpendicular cross axis 178 of the skateboard 10. The reinforcing material 74 further includes an anterior portion 182. The anterior portion 182 is located along the lengthwise axis 174 of the skateboard 10 and centered about mounting holes 186 for the first mounting plate 54. The reinforcing material 74 further includes a posterior portion 190. The posterior portion 190 is located along the lengthwise axis 174 of the skateboard 10 and centered about mounting holes 194 for the second mounting plate 58.

(13) In still a further variant, as illustrated in FIG. 3, the center portion 170 is adhered to the core layer 38 on a wood ply 198 located below a vertical center point 202 of the core layer 38.

(14) In yet a further variant, the anterior portion 182 and the posterior portion 190 are adhered to the core layer 38 on a wood ply 206 located above the vertical center point 202 of the core layer 38.

(15) In another variant of the invention, the center portion 170 is adhered to a wood ply 210 of the core layer 38 that has a defined wood grain 214 parallel to the wood grain direction 122 of the upper surface 86 of the lower layer 26.

(16) In still another variant, the anterior portion 182 and the posterior portion 190 are adhered to a wood ply 218 of the core layer 38 that has a defined wood grain 222 parallel to the wood grain direction 122 of the lower surface 82 of the upper layer 14.

(17) In yet another variant, as illustrated in FIG. 5, the center portion 170 is 1″ to 4″ in width and 18″ to 24″ in length.

(18) In a further variant, the anterior portion 182 and the posterior portion 190 are 1″ to 4″ in width and 3″ to 6″ in length.

(19) In still a further variant, as illustrated in FIGS. 1 and 2, the mounting hardware 70 extends through each of the upper layer 14, core layer 38 and lower layer 26 and is secured against an underside 226 of the mounting plates 54, 58 with threaded fasteners 230.

(20) In yet a further variant, the industrial wood glue 90 is selected from the group consisting of: polyvinyl acetate (PVA) 234, aliphatic resin (not shown), polyurethane (not shown), phenol formaldehyde (not shown), and resorcinol-formaldehyde (not shown).

(21) In another variant of the invention, the reinforcing material 74 ranges from 0.0005″ to 0.0015″ in thickness.

(22) In still another variant, the wood plies 18, 30, 42 range in thickness from range in thickness from 0.05″ to 0.08″.

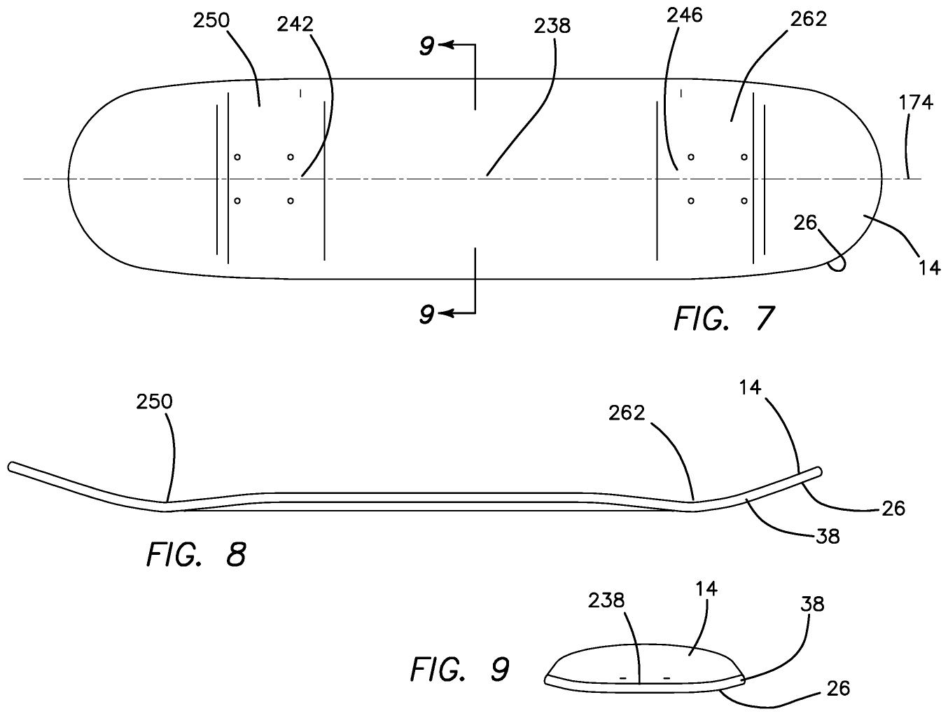

(23) In another variant of the invention, as illustrated in FIGS. 1, 2 and 6-9, the upper layer 14, the lower layer 26 and the core layer 38 further include a first concavity 238. The first concavity 238 is parallel to the lengthwise axis 174 and extends from a point 242 adjacent the first skateboard truck 46 to a point 246 adjacent the second skateboard truck 50.

(24) In still another variant, the first concavity 238 ranges from 0.25″ to 1.5″ in depth.

(25) In yet another variant, the upper layer 14, the lower layer 26 and the core layer 38 further include a second concavity 250. The second concavity 250 is perpendicular to the lengthwise axis 174, disposed adjacent the first skateboard truck 46 and extending from a first side edge 254 to a second side edge 258 of the layers 14, 26, 38.

(26) In a further variant, the second concavity 250 ranges from 0.25″ to 1.5″ in depth.

(27) In still a further variant, the upper layer 14, the lower layer 26 and the core layer 38 further comprise a third concavity 262, the third concavity 262 is perpendicular to the lengthwise axis 174, disposed adjacent the second skateboard truck 50 and extends from a first side edge 254 to a second side edge 258 of the layers 14, 26, 38.

(28) In yet a further variant, the third concavity 262 ranges from 0.25″ to 1.5″ in depth. The carbon fiber reinforced skateboard 10 has been described with reference to particular embodiments. Other modifications and enhancements can be made without departing from the spirit and scope of the claims that follow.

1. A carbon fiber reinforced skateboard comprising:
an upper layer, said upper layer being formed of at least a first wood ply and having an upper surface;
a lower layer, said lower layer being formed of at least a second wood ply and having a lower surface;
a core layer, said core layer being formed of at least a third wood ply and being disposed between said upper layer and said lower layer;
first and second skateboard trucks, said skateboard trucks having first and second mounting plates, first and second wheel sets, said wheel sets being rotatably mounted to said skateboard trucks, mounting hardware adapted to attach said mounting plates to at least said lower surface of said lower layer;
reinforcing material, said reinforcing material disposed between said upper layer and said lower layer;
an adhesive, said adhesive securing said reinforcing material to at least one of a lower surface of said upper layer, an upper surface of said lower layer or said core layer;
said upper layer, said lower layer and said core layer being laminated together using, pressure and industrial wood glue laminating material.

2. The carbon fiber reinforced skateboard, as described in claim 1, wherein said adhesive is an aliphatic rubbery synthetic polymer.

3. The carbon fiber reinforced skateboard, as described in claim 2, wherein said aliphatic rubbery synthetic polymer has a formula of (C₄H₆O₂)ₙ.

4. The carbon fiber reinforced skateboard, as described in claim 1, wherein said adhesive is selected from the group consisting of:
Polyvinyl acetate (PVA), PVAc and poly(ethenyl ethanoate).

5. The carbon fiber reinforced skateboard, as described in claim 1, wherein upper and lower wood plies of said core layer have a defined wood grain direction perpendicular to a wood grain direction of said lower surface of said upper layer and said upper surface of said lower layer.

6. The carbon fiber reinforced skateboard, as described in claim 5, wherein said core layer comprises at least three plies.

7. The carbon fiber reinforced skateboard, as described in claim 5, wherein a center ply of said core layer has a defined wood grain direction parallel to said wood grain direction of said lower surface of said upper layer and said upper surface of said lower layer.

8. The carbon fiber reinforced skateboard, as described in claim 5, wherein said core layer comprises at least five plies.

9. The carbon fiber reinforced skateboard, as described in claim 8, wherein said center ply of said core layer has said defined wood grain direction parallel to said wood grain direction of said lower surface of said upper layer and said upper surface of said lower layer and wood plies adjacent to said center ply have a defined wood grain direction perpendicular to said defined wood grain direction said center ply.

10. The carbon fiber reinforced skateboard, as described in claim 9, wherein wood plies adjacent to said lower surface of said upper layer and said upper surface of said lower layer have a defined wood grain direction parallel to said wood grain direction of said upper layer and said lower layer.

11. The carbon fiber reinforced skateboard, as described in claim 1, wherein said reinforcing material is selected from the group consisting of:
woven carbon fiber fabric, non-crimp stitch bonded carbon fiber fabric, stitch bonded carbon fiber fabric, and 45/−45 double bias carbon fiber fabric.

12. The carbon fiber reinforced skateboard, as described in claim 1, wherein said reinforcing material comprises:
a center portion, said center portion disposed along a lengthwise axis of said skateboard and centered on a perpendicular cross axis of said skateboard;
an anterior portion, said anterior portion disposed along said lengthwise axis of said skateboard and centered about mounting holes for said first mounting plate; and
a posterior portion, said posterior portion disposed along said lengthwise axis of said skateboard and centered about mounting holes for said second mounting plate.

13. The carbon fiber reinforced skateboard, as described in claim 12, wherein said center portion is adhered to said core layer on a wood ply disposed below a vertical center point of said core layer.

14. The carbon fiber reinforced skateboard, as described in claim 13, wherein said anterior portion and said posterior portion are adhered to said core layer on a wood ply disposed above said vertical center point of said core layer.

15. The carbon fiber reinforced skateboard, as described in claim 12, wherein said center portion is adhered to a wood ply of said core layer having a defined wood grain parallel to said wood grain direction of said upper surface of said lower layer.

16. The carbon fiber reinforced skateboard, as described in claim 12, wherein said anterior portion and said posterior portion are adhered to a wood ply of said core layer having a defined wood grain parallel to said wood grain direction of said lower surface of said upper layer.

17. The carbon fiber reinforced skateboard, as described in claim 12, wherein said center portion is 1″ to 4″ in width and 18″ to 24″ in length.

18. The carbon fiber reinforced skateboard, as described in claim 12, wherein said anterior portion and said posterior portion are 1″ to 4″ in width and 3″ to 6″ in length.

19. The carbon fiber reinforced skateboard, as described in claim 1, wherein said mounting hardware extends through each of said upper layer, core layer and lower layer and is secured against an underside of said mounting plates with threaded fasteners.

20. The carbon fiber reinforced skateboard, as described in claim 1, wherein said industrial wood glue is selected from the group consisting of:
polyvinyl acetate (PVA), aliphatic resin, polyurethane, phenol formaldehyde, and resorcinol-formaldehyde.

21. The carbon fiber reinforced skateboard, as described in claim 1, wherein the reinforcing material ranges from 0.0005″ to 0.009″ in thickness.

22. The carbon fiber reinforced skateboard, as described in claim 1, wherein said wood plies range in thickness from range in thickness from 0.05″ to 0.08″.

23. The carbon fiber reinforced skateboard, as described in claim 13, wherein said upper layer, said lower layer and said core layer further comprise a first concavity, said first concavity being parallel to said lengthwise axis and extending from a point adjacent said first skateboard truck to a point adjacent said second skateboard truck.

24. The carbon fiber reinforced skateboard, as described in claim 23, wherein said first concavity ranges from 0.25″ to 1.5″ in depth.

25. The carbon fiber reinforced skateboard, as described in claim 13, wherein said upper layer, said lower layer and said core layer further comprise a second concavity, said second concavity being perpendicular to said lengthwise axis, disposed adjacent said first skateboard truck and extending from a first side edge to a second side edge of said layers.

26. The carbon fiber reinforced skateboard, as described in claim 25, wherein said second concavity ranges from 0.25″ to 1.5″ in depth.

27. The carbon fiber reinforced skateboard, as described in claim 13, wherein said upper layer, said lower layer and said core layer further comprise a third concavity, said third concavity being perpendicular to said lengthwise axis, disposed adjacent said second skateboard truck and extending from a first side edge to a second side edge of said layers.

28. The carbon fiber skateboard, as described in claim 27, wherein said third concavity ranges from 0.25″ to 1.5″ in depth.

29. A method of making a carbon fiber reinforced skateboard, comprising the steps of:
forming an upper layer, said upper layer being formed of at least a first wood ply and having an upper surface;
forming a lower layer, said lower layer being formed of at least a second wood ply and having an lower surface;
forming a core layer, said core layer being formed of at least a third wood ply and being disposed between said upper layer and said lower layer;
providing first and second skateboard trucks, said skateboard trucks having first and second mounting plates;
providing first and second wheel sets, said wheel sets being rotatably mounted to said skateboard trucks;
providing mounting hardware, said mounting hardware being adapted to attach said mounting plates to at least said lower surface of said lower layer;
providing reinforcing material, said reinforcing material being disposed between said upper layer and said lower layer;
providing an adhesive;
securing said reinforcing material with said adhesive to at least one of a lower surface of said upper layer, an upper surface of said lower layer or said core layer;
laminating said upper layer, said lower layer and said core layer together using, pressure and industrial wood glue laminating material.

30. The method of making a carbon fiber reinforced skateboard, as described in claim 29, wherein said adhesive is an aliphatic rubbery synthetic polymer.

31. The method of making a carbon fiber reinforced skateboard, as described in claim 30, wherein said aliphatic rubbery synthetic polymer has a formula of (C₄H₆O₂)ₙ.

32. The method of making a carbon fiber reinforced skateboard, as described in claim 29, wherein said adhesive is selected from the group consisting of:
polyvinyl acetate (PVA), PVAc and poly(ethenyl ethanoate).

33. The method of making a carbon fiber reinforced skateboard, as described in claim 29, further comprising the step of orienting a defined wood grain direction of upper and lower wood plies of said core layer perpendicular to a wood grain direction of said lower surface of said upper layer and said upper surface of said lower layer.

34. The method of making a carbon fiber reinforced skateboard, as described in claim 29, further comprising the step of providing said core layer comprises with at least three plies.

35. The method of making a carbon fiber reinforced skateboard, as described in claim 29, further comprising the step of orienting a center ply of said core layer, having a defined wood grain direction, parallel to a wood grain direction of said lower surface of said upper layer and said upper surface of said lower layer.

36. The method of making a carbon fiber reinforced skateboard, as described in claim 29, further comprising the step of providing said core layer comprises with at least five plies.

37. The method of making a carbon fiber reinforced skateboard, as described in claim 29, further comprising the step of orienting said core layer such that a center ply of said core layer has a defined wood grain direction parallel to a wood grain direction of said lower surface of said upper layer and said upper surface of said lower layer and wood plies adjacent to said center ply have a defined wood grain direction perpendicular to said center ply.

38. The method of making a carbon fiber reinforced skateboard, as described in claim 29, further comprising the step of orienting said core layer such that wood plies adjacent to said lower surface of said upper layer and said upper surface of said lower layer have a defined wood grain direction parallel to a wood grain direction of said upper layer and said lower layer.

39. The method of making a carbon fiber reinforced skateboard, as described in claim 29, further comprising the step of providing reinforcing material selected from the group consisting of:
woven carbon fiber fabric, non-crimp stitch bonded carbon fiber fabric, stitch bonded carbon fiber fabric, and 45/−45 double bias carbon fiber fabric.

40. The method of making a carbon fiber reinforced skateboard, as described in claim 29, further comprising the steps of:
providing a center portion of said reinforcing material, said center portion being disposed along a lengthwise axis of said skateboard and centered on a perpendicular cross axis of said skateboard;
providing an anterior portion of said reinforcing material, said anterior portion being disposed along a lengthwise axis of said skateboard and centered about mounting holes for said first mounting plate; and
providing a posterior portion of said reinforcing material, said posterior portion being disposed along a lengthwise axis of said skateboard and centered about mounting holes for said second mounting plate.

41. The method of making a carbon fiber reinforced skateboard, as described in claim 40, further comprising the step of adhering said center portion to said core layer on a wood ply disposed below a vertical center point of said core layer.

42. The method of making a carbon fiber reinforced skateboard, as described in claim 40, further comprising the step of adhering said anterior portion and said posterior portion to said core layer on a wood ply disposed above a vertical center point of said core layer.

43. The method of making a carbon fiber reinforced skateboard, as described in claim 40, further comprising the step of adhering said center portion to a wood ply of said core layer having a defined wood grain parallel said wood grain direction of said upper surface of said lower layer.

44. The method of making a carbon fiber reinforced skateboard, as described in claim 40, further comprising the step of adhering said anterior portion and said posterior portion a wood ply of said core layer having a defined wood grain parallel to said wood grain direction of said lower surface of said upper layer.

45. The method of making a carbon fiber reinforced skateboard, as described in claim 40, wherein said center portion is 1″ to 4″ in width and 18″ to 24″ in length.

46. The method of making a carbon fiber reinforced skateboard, as described in claim 40, wherein said anterior portion and said posterior portion are 1″ to 4″ in width and 3″ to 6″ in length.

47. The method of making a carbon fiber reinforced skateboard, as described in claim 29, further comprising the steps of:
providing apertures for said mounting hardware that extend through said upper layer, said core layer and said lower layer;
disposing said mounting hardware through said apertures;
mounting said first and second mounting plates on said mounting hardware; and
securing said first and second mounting plates to said skateboard with threaded fasteners.

48. The method of making a carbon fiber reinforced skateboard, as described in claim 29, further comprising the step of providing industrial wood glue selected from the group consisting of:
polyvinyl acetate (PVA), aliphatic resin, polyurethane, phenol formaldehyde, and resorcinol-formaldehyde.

49. The method of making a carbon fiber reinforced skateboard, as described in claim 29, further comprising the step of providing reinforcing material having a thickness ranging from 0.0005″ to 0.009″.

50. The method of making a carbon fiber reinforced skateboard, as described in claim 29, further comprising the step of providing wood plies range in thickness from range in thickness from 0.05″ to 0.08″.

51. The method of making carbon fiber reinforced skateboard, as described in claim 40, wherein said upper layer, said lower layer and said core layer further comprise a first concavity, said first concavity being parallel to said lengthwise axis and extending from a point adjacent said first skateboard truck to a point adjacent said second skateboard truck.

52. The method of making carbon fiber reinforced skateboard, as described in claim 51, wherein said first concavity ranges from 0.25″ to 1.5″ in depth.

53. The method of making carbon fiber reinforced skateboard, as described in claim 40, wherein said upper layer, said lower layer and said core layer further comprise a second concavity, said second concavity being perpendicular to said lengthwise axis, disposed adjacent said first skateboard truck and extending from a first side edge to a second side edge of said layers.

54. The method of making carbon fiber reinforced skateboard, as described in claim 53, wherein said second concavity ranges from 0.25″ to 1.5″ in depth.

55. The method of making carbon fiber reinforced skateboard, as described in claim 40, wherein said upper layer, said lower layer and said core layer further comprise a third concavity, said third concavity being perpendicular to said lengthwise axis, disposed adjacent said second skateboard truck and extending from a first side edge to a second side edge of said layers.

56. The method of making carbon fiber reinforced skateboard, as described in claim 55, wherein said third concavity ranges from 0.25″ to 1.5″ in depth.
